(19) United States
(12) Patent Application Publication
(10) Pub. No.: US 2006/0259386 A1
(43) Pub. Date: Nov. 16, 2006

(54) Building digital assets for use with software applications

(76) Inventors: Kier Lee Knowlton, Orem, UT (US); John Andrew Renstrom, Orem, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/434,954

(22) Filed: May 16, 2006

Related U.S. Application Data
(60) Provisional application No. 60/681,452, filed on May 16, 2005.

(51) Int. Cl. G06Q 40/00; G06F 7/00; G06F 17/00

(52) U.S. Cl. 705/35; 707/100

(57) ABSTRACT

The present invention extends to methods, systems, and computer program products for building digital assets for use with software applications. When a digital asset is received, the digital can be classified based on digital asset type and/or a specified platform type where the digital asset is to be utilized. Digital assets are assigned build rules that can be at least partially inherited based on where the digital asset is stored. Build rules are stored along with corresponding assets in common data structures. When a build command is received, a build rule for a digital asset is accessed from the common data structure. Digital asset builds can be distributed across a plurality of salve modules that perform individual tasks of the build process. Different branches of a software application including different digital assets and/or different versions of digital assets can be maintained in parallel.

### CROSS-REFERENCE TO RELATED APPLICATIONS

The present application. Claims priority from U.S. provisional patent application Ser. No. 60/681,452, filed May 16, 2005 and entitled “SYSTEMS AND METHODS FOR ASSET MANAGEMENT” which provisional patent application is incorporated herein by reference in its entirety.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, electronic gamming, scheduling, and database management) that prior to the advent of the computer system were performed manually. More recently, computer systems have been coupled to one another and to other electronic devices to form both wired and wireless computer networks over which the computer systems and other electronic devices can transfer electronic data. As a result, many tasks performed at a computer system (e.g., playing electronic games, voice communication, accessing electronic mail, controlling home electronics, Web browsing, and printing documents) include communication (e.g., the exchange of electronic messages) between a number of computer systems and/or other electronic devices via wired and/or wireless computer networks.

Performing tasks at a computer system typically includes running an application program that is designed to perform the tasks. For example, to perform word processing a user can run an application program designed for word processing functionality.

Development of application programs typically includes a team of application developers developing different software modules. The different software modules are then built together into a software application. Within the software application, the different software modules interact to facilitate the desired functionality of the software application. For example, a text editor module, a spell checking module, a text formatting module, etc., can interact to provide word processing functionality.

Builds are what the industry refers to as a functioning executable program. Creating a build has historically been the responsibility of the application programmers, as they have typically had the technical expertise required to mesh the interoperating requirements of computer code.

To automate the process of building a software application, various tools and/or scripts can be used to prepare, refine, optimize, and compile code for use in the software application. Generally, an external build frame work and corresponding external set of rules control when and how the tools and scripts are applied to modules to build a software application. For example, a “make” framework can use a formulaic set of rules to control building a software application. The formulaic set of rules are constructed by the application developers based their understanding of how the different modules of a software application are to interact.

Formulaic rules can indicate module dependency between different modules, such as, for example, A+B+C=D. That is, modules A, B, and C are combined together to build module D. Formulaic rules can also indicate dependency on other rules. For example, Rule E Rule F. That is, the output of Rule E is provide as input to Rule F.

To build a software application, the make framework separately receives a formulaic set of rules for an application and the various different modules for the application as input. The make framework then automatically applies the formulaic rules to appropriate modules in defined order to build the software application. Thus, an external build framework, such as, for example, a make framework, can be used to significantly reduce the build time of softvare applications. Accordingly, application developers can be freed up to devote more time to developing application modules.

However, each time a portion of any module is changed the build process must be re-executed (either completely or incrementally) to generate a new version of the software application. Unfortunately, since various formulaic rules and modules can depend on one another, there is typically no way to bypass portions of the build process to only rebuild those modules that have changed. That is, when a number of other modules depend on a module that has changed, the dependent modules must also be rebuilt to incorporate changes from the changed module. Further, if the output of a first rule that processes the changed module is provided as input to another rule, the other rule must also be re-executed (even if no modules accessed in the other rule inherently depend on the changed module) to account for the potentially new value output from the first rule.

For software applications that primarily include code, such as, for example, business applications, re-execution of an entire build process to account for changes in a small number modules (or a single module) is often tolerable. Rebuilding code is typically reasonable efficient and does not require significant computer resources. Thus, the build process can be re-executed and the application developer simply waits for the build to complete. After the build is completed, the application developer executes the software application to determine if the changed is functioning appropriately.

Unfortunately, many software applications, such as, for example, electronic games and cinematic applications, include significant amounts digital content (e.g., pictures, video, and/or audio data) and reduced amounts of code. For example, the modules of a video game may be 10% code and 90% digital content. Building digital content into an application consumes significantly more resources and time than building code into an application. For example, rendering frames of a cinematic application can take hundreds of times longer than building code for a typically business application (word processor, spreadsheet application, etc).

As a result, typical external build frameworks are not well suited for building software applications that are to include significant amounts of digital content. For example, rebuilding a cinematic application or video game to incorporate changes to only a few frames of video, requires rebuilding the entire cinematic application or video game from scratch. Since rebuilding digital content is significantly more resource intensive and time consuming, cinematic applications and video games can take much longer to rebuild after changes are made.

With respect to video game development, the process of moving digital content (e.g., refereed to as “game assets”) from a creation phase into an implementation phase (i.e. successfully getting the asset into, and functioning correctly in a game engine) is a complex and time-intensive operation, prone to human error and costly mistakes.

The creation phase can be initiated by an artist who creates an asset, such as a 3D model mesh, an image, a sound-file, etc. After the file has been created, it must then be exported from its source application with its common format into a special platform or engine format. The exported format is determined by the gaming platform (PC, Xbox, GameCube, PS2, PSP, etc.) where the game is to be used. The gaming platform can also dictates many of the properties that the game asset is to possess. These properties must be set correctly at the time of export, or the game asset will run the risk of being unsuitable for use in the game, and could ultimately be responsible for crashes that prevent the game from functioning correctly on its target platform.

After exporting a game asset with its properties, the game asset is typically then provided as input to an external build framework and formulaic external rules are applied to the game asset to incorporate the games asset into the game. If tools and scripts in the framework are run out of order, or are not executed correctly, then the game asset could become corrupt and not function in the game, causing the game to crash.

Due at least in part to the sophistication of today's technology and the demands of typical consumers, most electronic entertainment, and especially electronic games, require assets to load, unload, and even stream data at extremely fast rates. If an electronic game has inefficiencies in the actual structure of the game data as it is organized on its medium (e.g. DVD, CD, computer hard-disk, etc.) then the game will not be able to run at its maximum potential.

To assist in keeping a game's data organized correctly for speed and efficiency, processed game assets are typically organized into packages. Packages are groupings or bundles of assets and/or data that are compressed or saved into a single file. Similar to the exportation of a single asset, packages usually contain specific properties that must be correctly assigned at the time of creation.

However, if a particular game asset is used in multiple ways/parts of a game, the game asset typically must be included in multiple packages. Thus, managing these files without a management system that can (i) delineate which package each and every asset belongs to and (ii) track all assets required by any particular package to insure that the asset is included can be very difficult. Similar to a corrupt asset, an asset missing from its respective package could also cause the game to crash.

Once a game asset is prepared, the game asset is incorporated along with all of the packages as well as other game data into the game engine through a build process. Only after a build is created can the game be tested to insure that all game assets have been processed correctly and implemented properly. If testing reveals that an asset is causing the game to not function, then the entire process must begin anew, until a new build is created and tested. Rebuilding is a tedious and time-consuming process must happen countless times in the process of creating an electronic game.

Further, the responsibility for managing each game asset typically falls on the individual artist who created the game asset. As modern games now tend to have tens of thousands of individual assets, this can be a daunting task. For example, each artist must manage his or her own archive of created game assets, the formats to which the assets must be exported, the properties that must be assigned thereto, and ultimately, all of the packages to which the assets belong. Thus, there is an increased risk for human error when managing individual game assists.

Unfortunately, when an error occurs it frequently adversely affects many other project members. In many cases, errors can cause development of the game to slow or even while the cause of the error is determined. Once a problem game asset identified, the creator of the game must then be identified, what went wrong, and how it can be remedied. Following this procedure, the asset must again be put through the entire preparation process before it can be resubmitted to the programming staff, who must again create a new build of the game for testing.

Another difficultly with typically build frameworks is the inability of one artist to concurrently edit any group of assets while another artist is editing the same group. Current asset management software is typically designed to prevent artists from overwriting each other's work by using a ‘check out’ system. The program keeps all files in a master repository, from which only one user may access any given file or package at a time. When a file is ‘checked out’ by one user, no other users may access that file in any way until the file is checked back in to the database.

Advantageously, this may prevent one user from overwriting another user's edits. However, existing asset management tools have at least one significant disadvantage. These asset management tools can only see files when the files reside in the tools' repository; they cannot differentiate between a single asset and a package of assets. Thus, for example, if a user needs to edit a single audio file which is contained in the ‘sound’ package and that package contains 100 individual audio files in it, the user is required to check out the whole package. Thus, all work by other users on the other 99 sound files must stop and wait until the first user has checked the entire package back into the database. Only then can a new user check out the package, again causing all other users to wait in line. This process can be very inefficient, leading to wasted development resources.

### BRIEF SUMMARY

The present invention extends to methods, systems, and computer program products for building digital assets into software applications. In some embodiments, a digital asset is built for use with a specified platform. A digital asset is received at a location within a namespace. The location is associated with an inheritable build rule. The contents of the inheritable build rule are attachable to digital assets stored at the location. The digital asset is classified based the digital asset being received at the location.

A corresponding build rule is attached to the digital asset to create a combined data structure that includes the digital asset and the corresponding build rule in response to receiving the digital asset. Accordingly, the corresponding build rule is stored along with the digital asset and the digital asset and the corresponding build rule can be accessed together in response to a build instruction to build the digital asset for a platform. The contents of the corresponding build rule are inherited at least in part from the inheritable build rule.

An instruction to build the digital asset for use on a specified platform is received. The combined data structure including the digital asset and the corresponding build rule is accessed. The corresponding build rule from the combined data structure is applied to the digital asset to convert the digital asset to a format compatible with the specified platform.

In other embodiments, the building of a digital asset is distributed. A digital asset that was exported from a digital asset design application at another computer system is received. A view of digital asset is provided to the other computer system through a user inbox for a user of the other computer system. A build command is received from the other computer system. The build command indicates a plurality of individual build tasks that are to be performed to appropriately build the digital asset for use with one or more specified platforms.

The digital asset is accessed from an asset repository. The build tasks are distributed to slave modules configured to perform individual build tasks such that the build command can be performed in parallel across a plurality of slave modules. Results are received from each slave module indicating the outcome of one or more distributed build tasks. One or more versions of the digital asset that were built through execution of the one or more distributed tasks are stored. The view of digital asset is update at the other computer system to indicate the one more versions of the digital asset that were built for specified platforms.

This summary is provided to introduce a selection of concepts in a simplified form that are further described below in the Detailed Description. This Summary is not intended to identify key features or essential features of the claimed subject matter, nor is it intended to be used as an aid in determining the scope of the subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates building a digital asset for a use with a specified platform.

FIG. 2 illustrates a flow chart of an example method for building a digital asset for use with a specified platform.

FIG. 3 illustrates an example computer architecture that facilitates distributing building of a digital asset.

FIG. 4 illustrates a flow chart of an example method for distributed building of a digital asset.

FIG. 5 illustrates various different branches of a software application that includes digital assets.

### DETAILED DESCRIPTION

The present invention extends to methods, systems, and computer program products for building digital assets for use with software applications. In some embodiments, a digital asset is built for use with a specified platform. A digital asset is received at a location within a namespace. The location is associated with an inheritable build rule. The contents of the inheritable build rule are attachable to digital assets stored at the location. The digital asset is classified based the digital asset being received at the location.

A corresponding build rule is attached to the digital asset to create a combined data structure that includes the digital asset and the corresponding build rule in response to receiving the digital asset. Accordingly, the corresponding build rule is stored along with the digital asset and the digital asset and the corresponding build rule can be accessed together in response to a build instruction to build the digital asset for a platform. The contents of the corresponding build rule are inherited at least in part from the inheritable build rule.

An instruction to build the digital asset for use on a specified platform is received. The combined data structure including the digital asset and the corresponding build rule is accessed. The corresponding build rule from the combined data structure is applied to the digital asset to convert the digital asset to a format compatible with the specified platform.

In other embodiments, the building of a digital asset is distributed. A digital asset that was exported from a digital asset design application at another computer system is received. A view of digital asset is provided to the other computer system through a user inbox for a user of the other computer system. A build command is received from the other computer system. The build command indicates a plurality of individual build tasks that are to be performed to appropriately build the digital asset for use with one or more specified platforms.

The digital asset is accessed from an asset repository. The build tasks are distributed to slave modules configured to perform individual build tasks such that the build command can be performed in parallel across a plurality of slave modules. Results are received from each slave module indicating the outcome of one or more distributed build tasks. One or more versions of the digital asset that were built through execution of the one or more distributed tasks are stored. The view of digital asset is update at the other computer system to indicate the one more versions of the digital asset that were built for specified platforms.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise computer-readable storage media, such as, RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer, the computer properly views the connection as a computer-readable medium. Thus, by way of example, and not limitation, computer-readable media can comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, hand-held devices, multi-processor systems, microprocessor-based or programmable consumer electronics, network PCs, minicomputers, mainframe computers, mobile telephones, PDAs, console gaming devices, handheld gaming devise, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In this description and in the following claims, a “platform” is defined as one or more identified hardware and/or software components that indicate a development environment. It may be that a combination of different hardware and software components is used to indicate a platform. For example, an Intel processor running Microsoft® Windows® XP can be used to identify a platform. Alternately, a single component can be used alone to indicate a platform. For example, Nintendo® Game Boy® can be used to indicate a platform. In some embodiments, a platform is identified by the game engine, for example, unreal engine, source engine, C4 engine, etc, that is to utilize the digital asset.

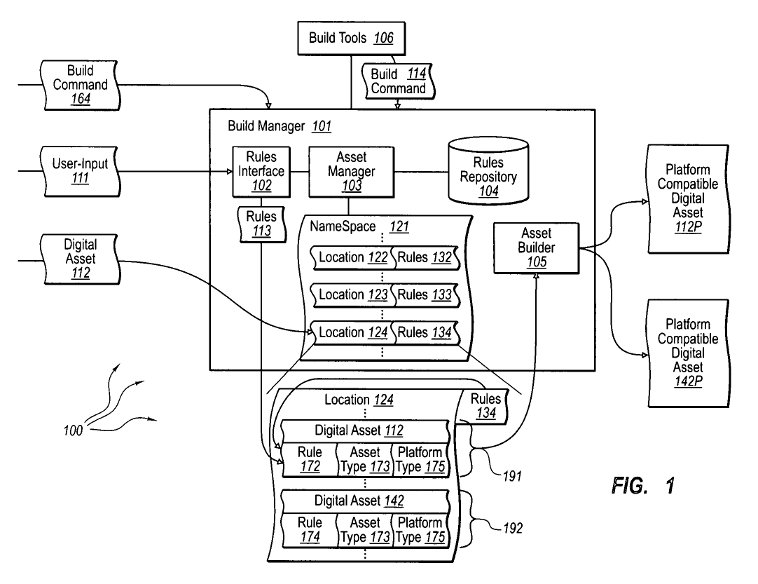

FIG. 1 illustrates an example computer architecture 100 that facilitates building a digital asset for a specified platform. Components at and included in computer architecture 100 can be connected to a network. The network can be any type of network, such as, for example, a Local Area Network (“LAN”), a Wide Area Network (“WAN”), or even the Internet. Thus, the various components at and included in computer architecture 100 can receive data from and send data to each other, as well as other components connected the network. Accordingly, the components can create message related data and exchange message related data (e.g., Internet Protocol (“IP”) datagrams and other higher layer protocols that utilize IP datagrams, such as, Transmission Control Protocol (“TCP”), Remote Desktop, Protocol (“RDP”), Hypertext Transfer Protocol (“HTTP”), Simple Object Access Protocol “SOAP”) etc.) over the network.

As depicted, computer architecture 100 includes build manager 101. Build manager 101 is configured to receive build commands, for example, received through user input and/or from other build tools (e.g., from among build tools 106), and build a digital asset for a specified platform. In some embodiments, digital assets are built for specified electronic gaming or computer generated cinematic platforms. For example, digital assets can be built for a variety of console gaming platforms, handheld gaming platforms, personal computer gaming platforms, etc., as well as computer generated cinematic platforms.

Build manager 101 includes rules interface 102, asset manager 103, asset builder 105, build rules 104, and namespace 121.

Generally, rules interface 102 can receive user-input and formulate build rules based on user-input. Formulated build rules can be used to build digital assets for a specified platform.

Generally, namespace 121 provides addressable locations that can be used to store and access digital assets. Namespace 121 can be a directory structure accessible to an operating system used at computer architecture 100. Namespace 121 can be configured such that similar types (or the same type) of digital assets are stored in the same location and different types of digital assets are stored in different locations. In some embodiments, namespace 121 is a hierarchical directory structure. Similar types (or the same type) of assets can be grouped (stored) in the same (sub-directory within hierarchical directory structure 121. For example, all graphical in assets in a bit-mapped graphics format (“BMP”) can be stored in the same directory within namespace 121 (e.g., location 122). On the other hand, different types of assets are grouped (stored) in different (sub-)directories within hierarchical directory structure 121. For example, BMP graphical assets can be stored in a first directory (e.g., location 122), Joint Photographic Experts Group (“JPEG”) graphical assets can be stored in a second different directory (e.g., location 123), WAV format audio assets can be stored in a third different directory (e.g., location 124), etc.

Portions of namespace 121 can be allocated on a per platform basis. For example, a first sub-tree of directories can be allocated for storing assets for a first platform, a first sub-tree of directories can be allocated for storing assets for a second platform, etc. When an asset is to be used with a specified platform, the asset can be copied (or moved) into the appropriate directory within the sub-tree associated with the specified platform.

Generally, rules repository 104 can store build rules entered through rules interface 102 and/or received from other locations (e.g., from other build managers, from other build tools, copied from other namespaces, etc.).

Generally, asset manager 103 is configured to control access to and manipulation of digital assets within namespace 121. Asset manager 103 manages the association of rules with digital assets and allocates digital assets for building for specific platforms. For example, when a digital asset is received into namespace 121, asset manager 103 can attach a build rule to the received digital asset. The build rule can indicate how the digital asset is to be processed to prepare the digital asset for use with a specified platform.

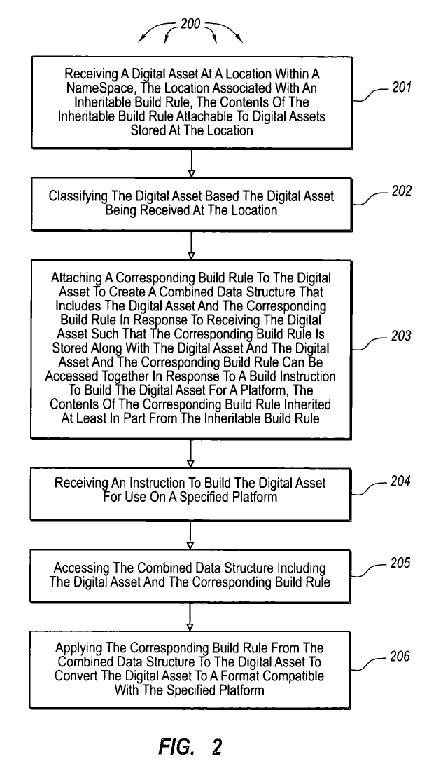

FIG. 2 is flowchart of an example method 200 for building a digital asset for use with a specified platform. The method 200 will be described with respect to the components and data in computer architecture 100.

Method 200 includes an act of receiving a digital asset at allocation within a namespace (act 201). The location being associated with an inheritable build rule, the contents of which are attachable to digital assets stored at the location. For example, digital asset 112 can be received at location 124. Digital asset 112 can be copied (or moved) from another storage location accessible to computer architecture 100 (even from another location in namespace 121) to location 124. Digital asset 112 can be stored in location 124 along with other digital assets of similar (or the same) type, such as, for example, digital asset 142.

Through user-input (e.g., command line commands or use of a drag and drop operation in a graphical user interface (“GUI”)), a user can cause digital asset 112 to be copied (or moved) from another location to location 124. Alternately, reception at build tools 106 or some other build tool or reception at another build manager can cause digital asset 112 to automatically be copied (or moved) to location 124.

Method 200 includes an act of classifying the digital asset based the digital asset being received at the location (act 202). For example, asset manager 103 can classify digital asset 112 in response to the reception of digital asset 112 can location 125. Classifying a digital asset can include classifying a digital asset by type and by intended platform. In some embodiments, classification of asset type and/or platform type is inferred from the configuration and/or information related to namespace 121 and/or location 124. For example; asset manager 103 can classify digital asset 112 into asset classification 173 and platform type 175 based on reception of digital asset 112 can location 124. It may be that location 124 is part of a directory sub-tree of namespace 121 allocated for receiving BMP digital assets for use on a Microsoft® Xbox platform. Thus, it can be inferred based on reception of digital asset 112 at location 124 that digital asset 124 is a BMP digital asset for use on the Microsoft® Xbox platform.

In other embodiments, a digital asset is received along with an asset type and/or platform type that are to be assigned to the digital asset. For example, digital asset 112 can be received along asset type 173 and platform type 175. When appropriate, reception of asset type 173 and platform type 175 may be used to determine that asset 112 is to be copied (or moved) into location 124. For example, in embodiments where namespace 121 is unstructured, asset manager 103 can use type 173 and platform type 175 to determine that digital asset 112 is to be moved to location 124.

A digital asset classification type that can include multiple levels of detail; including identifying which particular levels and platforms a digital asset is to be use for. For example, a digital asset can be classified for a specific platform, specific language of a game, and for specified levels within the game. Thus, different digital assets can be used for different platforms that enable greater or lesser game resolutions. By automatically designating digital assets for specified platforms, human error reduced and digital assets can be built more efficiently

Method 200 includes an act of attaching a corresponding build rule to the digital asset to create a combined data structure that includes the digital asset and the corresponding build rule in response to receiving the digital asset (act 203). For example, asset manager 103 can create data structure 191 for storing digital asset 112. Asset manager 103 can attach rule 172 to data structure 191. Thus, rule 172 is stored along with digital asset 112. Accordingly, rule 172 and digital asset 112 can be accessed together in response to a build instruction to build digital asset 112 for a specified platform.

The contents of rule 172 can be inherited at least in part from rules 134. Rules 134 can include one or more rules for processing the type of digital asset stored in location 124 (e.g., BMP graphical assets) for use with a platform (e.g., Microsoft® Xbox) corresponding to the sub-tree of directories within namespace 121 that includes location 124. When appropriate, the contents of rule 172 can be modified by rules 113. Rules 113 can be generated in response to receiving user-input 111 at rules-interface 102. Rules for other digital assets, such as, for example, rule 174 can also be partially inherited and partially received from user-input.

Generally, when a digital asset is received, a user can select different properties and assets of the digital asset. For example, a video digital asset can be extremely large, such as 50 Gig in its raw uncompressed form. It may be appropriate to store the video digital asset in a lossless compressed format to reduce storage requirements. However, the raw uncompressed data may be faster to access. Thus, n response to receiving the video digital asset, a user can identify what format the video digital asset is to have, and asset manager 103 can take appropriate action to store the video digital asset in the identified format.

In some embodiments, an asset classification and/or platform classification are expressly assigned to a combined data structure used to store the digital asset and corresponding build rule. For example, asset type 173 and platform type 175 can be expressly assigned to data structure 191 to represent an asset classification and platform classification of asset 112. Thus, if digital asset 112 is moved from location 124 a previous (and potentially original) asset type and platform type is accessible.

Method 200 includes an act of receiving an instruction to build the digital asset for use on a specified platform (act 204). For example, build manager 101 can receive build command 114 from build tools 106. Build command 114 can include a build instruction to build one or more digital assets stored in namespace 121 for use with a specified platform. For example, build command 114 can include build instructions to build digital assets 112 and 142.

Build command 114 may or may not expressly specify a platform type. When a platform type is not expressly specified, asset build 105 can infer a platform type from information related to the configuration of namespace 121 and/or location 124. For example, asset builder 105 can infer platform type 175 for digital assets 112 and 122 based on digital assets 112 and 122 being stored in location 124. Alternately, asset builder 105 can access platform type 175 from data structures 191 and 192.

When a platform type is expressly specified in build command 114, asset builder 105 can use the expressly specified platform type (e.g., overriding the specification of platform type 175).

Method 200 includes an act of accessing the combined data structure including the digital asset and the corresponding build rule (act 205). For example, asset builder 105 can access data structures 191 and 192 to obtain rules 172 and 174 for building digital assets 112 and 142 respectively.

Method 200 includes an act of applying the corresponding build rule from the combined data structure to the digital asset to convert the digital asset to a format compatible with the specified platform (act 206). For example, asset builder 105 can applying rule 172 to digital asset 112 to convert digital asset 112 to platform compatible digital asset 112P. Likewise, asset builder 105 can applying rule 174 to digital asset 142 to convert digital asset 142 to platform compatible digital asset 142P.

As previously described, a build rule can indicate how a digital asset is to be processed to prepare the digital asset for use with a specified platform. Build rules can be applicable to any graphical assets, video assets, audio assets, etc. that can be used in an electronic game or computer generated cinematic platform. Build rules can indicate that a digital asset is to be converted between different formats, for example, converting a BMP digital asset to a JPEG digital asset. Build rules can indicate that the size of a digital asset is to changed, for example, compressing or expanding, the size of the digital asset. Build rules can indicate that the original content of a digital asset is to be modified in some way, for example, adding reverb to an audio digital asset.

These and other build rules can be associated with locations in namespace 121 and inherited (at least in part) by digital assets that are copied into corresponding locations. If inherited build rules do not provide an appropriate platform compatible digital asset (e.g., an echo effect is too great), a user can modify the inherited rules through rules interface 102 to make appropriate adjustments (e.g., lower a reverb property). Thus, build rules can be automatically assigned and are also flexibly alterable based on the needs of specified platform.

Asset manager 103 can also be configured to package one or more digital assets into a single data file containing all the data from one or more digital assets.

Accordingly, embodiments of the present invention automate a chain of events, for example, a pipeline, used to get a digital asset from an asset developer into an application, such as, for example, a game build or computer generated cinematic build. An asset developer can drag and drop a digital asset in its original format into a build manager. The build manager then automates the operation of exporting that asset to a platform specific format and also assigning appropriate properties for building the digital asset. Since rules are assigned to and travel along with digital assets, there is little if any need to maintain a separate build infrastructure and iterate over a large plurality of different digital assets when a smaller plurality of digital assets or a single digital asset is to be built.

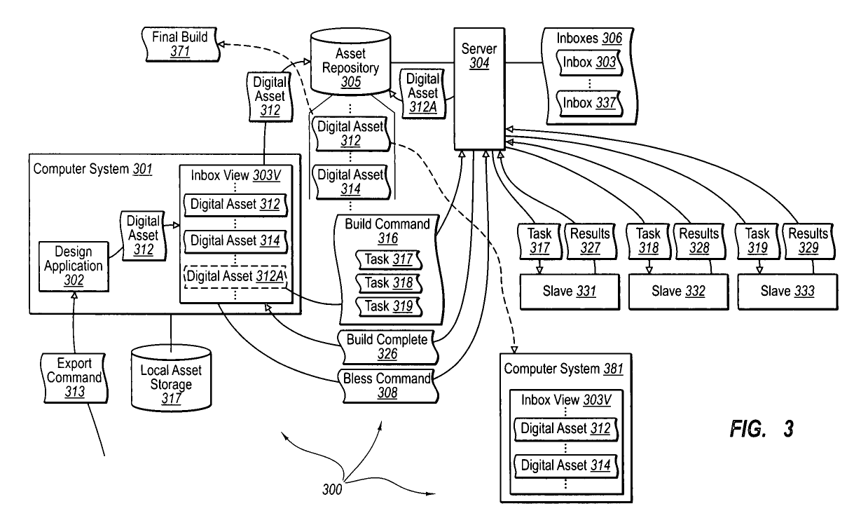

In some embodiments, digital assets are built in a distributed environment. FIG. 3 illustrates an example computer architecture 300 that facilitates distributing building of a digital asset. Components at and included in computer architecture 300 can be connected to a network. The network can be any type of network, such as, for example, a Local Area Network (“LAN”), a Wide Area Network (“WAN”), or even the Internet. Thus, the various components at and included in computer architecture 300 can receive data from and send data to each other, as well as other components connected the network. Accordingly, the components can create message related data and exchange message related data (e.g., Internet Protocol (“IP”) datagrams and other higher layer protocols that utilize IP datagrams, such as, Transmission Control Protocol (“TCP”), Remote Desktop Protocol (“RDP”), Hypertext Transfer Protocol (“HTTP”), Simple Object Access Protocol “SOAP”) etc.) over the network.

Depicted in FIG. 3 are computer systems 301 and 381 and server 304. Computer system 301 includes design application 302, inbox view 303V, and local asset storage 307. Design application 302 can be an application used by a digital asset developer asset to develop digital assets. When the digital asset developer has an digital asset they believe to be appropriate for use they can export the digital asset into an appropriate inbox. For example, a digital asset developer can issue export command 313 to export digital asset 312 to inbox view 303. Inbox view 303V represents a virtual view of inbox 303 that provides access to digital assets stored at asset repository 305. In response to exportation into inbox 303, digital asset 312 can be copied from computer system 301 to asset repository 305. Inbox view 303V can also provide a view of local storage devices, such as, for example local asset storage 307, at computer system 301.

When appropriate, computer system 301 can also include any of the modules depicted in computer architecture 100.

Server 304 includes asset repository 305 and inboxes 306. Asset repository 305 includes digital assets exported into or generated at the various inboxes included in inboxes 306. In some embodiments, each user (e.g., each digital asset developer) has a corresponding inbox for accessing digital assets from asset repository 305. A user can view various digital assets form asset repository 305 through a corresponding inbox view. For example, a user of computer system 301 can view digital assets 312 and 314 through inbox view 303V.

Inboxes can be associated with a primary user that uses the inbox to interface with asset repository 305. However, computer architecture 300 can have an open access policy such that users and computer systems can access any inbox. For example, a user at computer system 381 can also access inbox view 303V (potentially simultaneously with computer system 301). As a user at computer system 301 changes assets inbox view 303V the changes can be reflected at computer system 381.

Users can also make local copies of digital assets that are not accessible to other computer systems. For example, a user of computer system 301 can copy a version of a digital asset into local asset storage 307 to isolate (or “sandbox”) the version of the digital asset from other computer systems.

When appropriate, server 304 can also include any of the modules depicted in computer architecture 100. For example, server 304 can include a namespace for categorizing any assets that are received into asset repository 305. Thus, server 304 can attach build rules to received digital assets such that the build rules travel along with the digital assets as they are copied and/or moved among computer systems in computer architecture 300.

Through an inbox view a user can configure how various digital assets are to be built for use with one or more specified platforms. A user can manipulate the properties of an asset through inbox view to configure a digital to be built for use with a plurality of different specified platforms. When a user deems configuration to be appropriate, the used can issue a corresponding build command. For example, build command 316 can be issued to build digital asset 312.

As depicted, build command 316 includes tasks 317, 318, and 319, indicating the various different tasks that are to be performed to build digital asset 312 in accordance with a users desires. Tasks 317, 318, and 319 can indicate that digital asset 312 is to be built for three different specified platforms. On the other hand, tasks 317, 318, and 319 can indicate a group of tasks that are to be performed to build digital asset 312 for a single specified platform. Combinations of tasks are also possible. For example, building for a first platform may be associated with a plurality of different tasks (e.g., tasks 317 and 318), while building for a second platform is associated with a single task (e.g., task 319).

Build command 316 can be received at server 304. Server 304 can identify the different tasks 317, 318 and 319 included in build command 316. Server 304 can include internal modules to identify the tasks. Alternately, server 304 can delegate task identification (via a network or local bus request) to some other module or some other computer system. After identification, the other module or other computer system can return the identified tasks back to server 304.

Server 304 can distribute tasks 317, 318, and 319 to slave processing modules in computer architecture 300. Salve processing modules can include functionality similar to asset builder 105 for applying rules (potentially stored in common data structures along with digital assets) to digital assets to build the digital assets for a specified platform.

In some embodiments, computer-architecture 300 includes dedicated slave computers for with slave modules for building digital assets. In other embodiments, one or more computer systems (e.g., computer system 301 and 381) include slave modules for building digital assets in addition to modules for performing other functions (e.g., accessing inboxes and designing digital assets). In yet other embodiments, dedicated slave computers as a well as other computers with other modules coexist.

If a sufficient number of slave modules are available, all the tasks associated with a build command are distributed out at essentially the same time. For example, if each of slaves 331, 332, and 33 are available at or near the time build command 316 is received. Each of tasks 317, 318 and 319 are distributed to slaves 331, 322, and 333 respectively at essentially the same time. On the other hand, if a sufficient number of slave modules are not available, tasks associated with a build command can be distributed as slave modules are freed up. For example, if slave 333 is busy at or near the time build command 316 is received, tasks 317 and 318 are distributed to slaves 331 and 322 respectively at essentially the same time. If during processing of tasks 317 and 318, slave 33 then becomes available, task 319 can be distributed to slave 333.

When a slave successfully performs a task it can return results of performing the task along to server 304. For example, slaves 331, 332, and 333 can return corresponding results 327, 328, and 329 respectively to indicate that tasks 317, 318, and 319 are completed respectively. Server 304 can include a module configured to combine results from different tasks into an appropriate format for storage in asset repository 305. Accordingly, server 304 can receive results from slaves 331, 332, and 333 and incorporate the results into asset repository 305. For example, if tasks 317, 318, and 319 indicated builds for different platforms, server 304 can store a different version of digital asset 312 for each of the different platforms.

In response to completion, server 304 can send build complete to 326 to inbox 303. The build complete can be reflected at inbox view 303V by inbox view 303V displaying representative information for the three different versions of digital asset 312. A user of computer system 301 can take various different versions and test them on the corresponding platform. For example, a version of digital asset could be copied to a mobile phone for testing a version of an electronic game designed for the mobile phone.

If the user of computer system deems the version of digital asset 312 copied to the digital phone to be appropriate, the user can bless the version digital asset 312 for use in the final build of the electronic game. If the user has proper permission the version of digital asset 312 can be copied into final build 371. Otherwise, the version of digital asset 312 can be copied to another location, for example, to a supervisor's or testing department's inbox for further testing. After further review and/or testing the supervisor or testing department can further bless the version of digital asset 312. The version of digital asset 312 can then be copied into final build 371.

Slaves can return an error message is a task fails for some reason. When an error message is received form any slave, server 304 can indicate to computer system 301 that build command 316 has failed.

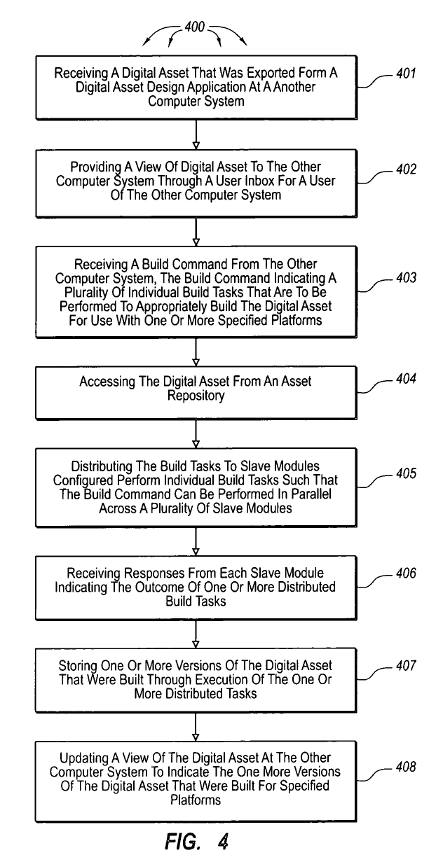

FIG. 4 illustrates a flow chart of an example method 400 for distributed building of a digital asset. The method 400 will be described with respect to the components and data in computer architecture 300.

Method 400 includes an act of receiving a digital asset that was exported form a digital asset design application at another computer system. For example, server 304 can receive digital asset 312 (e.g., a graphical, video, or audio asset) that was exported form design application 302. Server 304 can stored digital asset 312 in asset repository 305. Server 304 can assign one or more build rules to digital asset 312 when digital asset 312 is received. Rules can be assigned (and potentially partially inherited) based on a storage location in asset repository 305. For example, asset repository can represent a global namespace for digital assets of computer architecture 300. Server 304 can function similarly to asset manager 103 to assign build rules to digital assets and classify digital assets based their location within the global namespace.

Embodiments of the present invention can reduce the time associated with exporting data. An asset manager or inbox view can export data (e.g., digital asset 312) in a generally raw format (e.g., instead of preparing exported data at the time of export for a specified platform). Processing, such as, for example, compression is then performed at build time. Use of a raw format facilitates quick and efficient reformatting of data at subsequent times without re-exporting data from the artist or other individual. Build rules can be applied to the digital asset in the raw format to manipulate the digital asset without having to re-export the digital asset to apply different build rules.

Method 400 includes an act of providing a view of the digital asset to the other computer system through a user inbox for a user of the other computer system (act 402). For example, server 304 can provide inbox view 303V including digital asset 312 to computer system 301.

Method 400 includes an act receiving a build command from the other computer system, the build command indicating a plurality of individual build tasks that are to be performed to appropriately build the digital asset for use with one or more specified platforms (act 403). For example, server 304 can receive build command 316, including tasks 317, 318, and 319 from computer system 301. Tasks 317, 318, and 319 can indicate how to appropriately build digital asset 312 for use with one or more specified platforms.

Method 400 includes an act of accessing the digital asset from an asset repository (act 404) For example, server 304 can access digital asset 312 from asset repository 305. Method 400 includes an act of distributing the build tasks to slave modules configured to perform individual build tasks such that the build command can be performed in parallel across a plurality of slave modules (act 405). For example, server 304 can distribute build tasks 317, 318 and 319 to slaves 331, 332, and 333 respectively such that build command 316 can be performed in parallel across slaves 331, 332, and 333.

Method 400 includes an act of receiving results from each slave module indicating the outcome of the one or more distributed build tasks (act 406). For example, server 304 can receive results 327, 328, and 329 from slaves 331, 332, and 33 respectively indicating the outcome of tasks 317, 318, and 319 respectively. Method 400 includes an act of storing one or more versions of the digital asset that were built through execution of the one or more distributed tasks (act 407). For example, server 304 can combine results 327, 328, and 329 into appropriate versions of digital asset 312. Server 304 can store the appropriate versions of digital asset 312 in asset repository 305. For example, server 304 can store digital asset 312A. Digital 312A can be a version of digital assert 312 that was built for a specified platform.

Method 400 includes an act of updating a view of the digital asset at the other computer system to indicate the one more versions of the digital asset that were built for specified platforms (act 408). For example, serer 304 can update inbox view 303V to include digital asset 312A

Accordingly, the present invention combines the data preparation and conversion process, packaging, tasks, and data delivery with the version control of Assets. The automation of an asset pipeline reduces the risk of human error in the process or flow of converting electronic data files from one format/location to another. By associating asset properties with each asset, subsequent asset imports can retain their previous properties removing the error prone process of specifying properties each time the asset is imported.

Embodiments of the invention also facilitate user checkout of digital assets on per asset basis allowing multiple users to work on digital assets of a package simultaneously. As projects are created, copies of the project can be distributed to each workstation. Distributing projects allows all digital asset developers to work on the project at the same time. Packages can be rebuilt locally, tested for integrity, and then once an digital asset is resubmitted into the master project repository, a server can do all the work of organizing the new asset and rebuilding packages.

Computer systems, such as, for example, that depicted in computer architecture 100, and computer systems 301 and 381 can include any of a number of different graphical user interfaces to facilitate access the various functionality of the client application. For example, the client application can include an asset manager, accessible via a tab, drop down menu, etc. The asset manager can include a series of digital assets that an artist, programmer, game developer, etc has imported in and an in-box, (e.g., which functions similarly to an electronic mail inbox).

Each digital asset can be manipulated by accessing various functions of the asset manager, such as by right-clicking the asset or selecting tabs or drop down menus. For example, a user can select one or more digital assets, and when the user has completed working on the digital asset, tested it, and determined that the digital asset is appropriate for inclusion in the master repository, the user can “bless” the digital assets. To begin the “bless” process the user can click on a bless GUI and it brings up a dialogue and during this dialogue the user identifies the reason for “blessing” the one or more digital assets. This enables subsequent users to determine the reason for “blessing” the asset. Optionally, during the “bless” process an email communication can be sent to other members of the team or those individuals that can access the application of the present invention indicating the “blessing” of the asset. A project manager, or some other individual, can identify those individuals that will receive such a communication.

Generally, command line execution and/or dynamic link libraries (“DLLs”) can be used to launch or access functionality of third party applications, such as, but not limited to a packaging tools and applications. For example, a third party application can be used to perform the packaging process of digital assets. Functionality is configurable and customizable with respect to command line definitions, parameters, and details and the manner by which third party applications are launched and data transferred between an asset mangier and the third party applications. Command strings, tokens, etc. can be used with the command line functionality and can be edited and changed as needed, such as, but not limited to, on a per project basis. Third party applications can include, but are not limited to, optimizers that speed up game play, compressing tools, packaging tools, tools to perform new functionality to aid a particular project, plug-ins, etc.

When appropriate, digital assets can be locked to prevent access to the digital assets. For example, an artist or designer can lock an asset to prevent anyone else on the team from manipulating and/or blessing the digital asset them. Assets can be locked from either an asset manager (at a computer system or server) or a third party editor application that can be a standalone application or integrated into an asset manager. DLLs along with a command line can be used to integrate an editor application into an asset manager. An imbedded scripting language can be used within the editor application to call to the command line of the asset manager. Thus, a designer or artist can remain within the editor application and is not required to switch applications to obtain the functionality of the asset manager. In other embodiments, a digital asset can be automatically locked upon a user opening the digital asset and can notify other users when they attempt to open the asset.

Asset mangers (e.g., asset manager 103 or an asset manger at server 304) can also be configured generate reports based upon asset classifications. For example, as described each digital asset can have an asset type, (e.g., a texture, an animation, a model, a level, a sound, etc). Using a project tree graphical representation accessible through a GUI, a user can generate a report by right clicking on a parent node, specify a date range, and identify which digital assets to search. Searches can be filtered based upon any of the types or categories defined in the application. The resultant report can be manipulated and digital assets selected directly from the generated report. The report is an active document and every one of the identified assets is accessible through links in the report. Accordingly, digital assets can be selected deleted, reprocessed, etc., through a report.

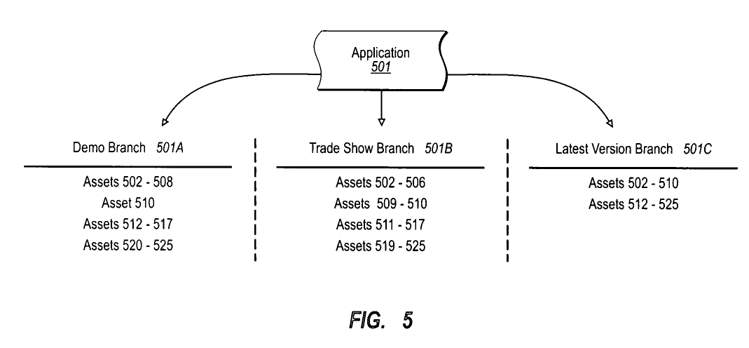

Embodiments of the present invention can maintain multiple branches of a application, such as, for example, an electronic game or computer generated cinematic application, for different purposes and/or that include at least some differently configured digital assets. FIG. 5 illustrates various different branches of a software application that includes digital assets. As depicted, application 501 is represented by demo branch 501A, trade show branch 501B, and latest version 501C.

An asset manager through a user-interface can allow a user to place copies of digital assets and packages into specific branches corresponding to a software application. A designer or artist can select a project and what branch of the project they want to access.

As depicted demo branch 501A includes assets 502-508, 510, 512-517, and 520-525. Tradeshow branch 501B includes assets 502-506, 509-510, 511-517, and 519-525. Latest version branch 501C includes assets 502-510 and 512-525.

Digital assets included in demo branch 501A can be used in a version of application 501 that is primarily given as a demonstration of the functionality of application 501. Digital assets in trade show branch 501B can be used in a version of application 501 that is primarily shown at trade shows. Digital assets in latest version branch 501C can be used in a most recent version of application 501. For various reasons it may not be appropriate to include digital assets from branch in another branch. For example, digital assets in branch 501C may not be appropriate for other branches until fully tested or digital asset 511 may represent specified functionality desired at a tradeshow.

However, an artist or designer can also change the association of assets and packages from one branch to another or all branches by changing the properties of the asset and/or package. By running a compare report between branches, assets and packages that are different can be identified, and the reasons they are different, and there association quickly and efficiently changed. For example, reports can be generated that identify the reason assets are different.

Generally, by allocating assets on a branch level, changes to one branch do not affect alternate branches. Local branches associated with the local drive(s) can be used so that a designer or artist can test and manipulate the digital assets locally without the possibility of adversely affecting other globally accessible branches. For example, a local drive can include a local version of demo branch 501A, a local version of tradeshow branch 501B, and local version of latest version branch 501C that are separate, for example, form versions stored in asset repository 305. Thus, branches facilitate efficient digital asset and package changes without adversely affecting the progress of electronic game or cinematic application development.

Branches also facilitate testing and developing content for multiple versions of an electronic game or computer generated cinematic application in parallel. One branch can be selected as the current branch for example, latest version branch 501C, while another branch can be the stable branch used by the testing department. Through use of the present invention, structured testing of digital assets and packages can be performed as a testing department, using the system of the present invention, controls the digital assets and packages used with particular. For example, individual levels of a game can be tested before they are added to the stable branch or the current branch. The testing department also has a roadmap of changes to be made. For example, the system can be configured so that any changes to the game i.e., blessed assets, have to be sent to testing before they are posted to the master repository and the current branch, i.e., the most current version of the game.

According to other embodiments, the server and copter system functionality is distributed across one or more servers and one or more computer systems For example a master server can communicate with one or more secondary servers at various remote locations. The secondary servers can sync with the master server, thereby allowing the users at the remote server access to the same updated data for the game, assets, and packages (e.g., from asset repository 305). The master and secondary servers can sync data form time to time or at regular intervals such as, every data, hour, etc.

Thus, a publisher house can have a single master server and multiple satellite services at various designers, developers, etc. to enable all parties to work on a single project. Each computer system can have access to the local branches and in-box of other computer systems. Further, if the publisher determines that additional artists are to be brought online to complete the project, the publisher can deliver a secondary server to the artist. Once the secondary server is synced with the master server, the artist is current with data they need to start working on the project.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, a method for building a digital asset for use with software application, the method comprising:
an act of receiving a digital asset at a location within a namespace, the location associated with an inheritable build rule, the contents of the inheritable build rule attachable to digital assets stored at the location;
an act of classifying the digital asset based the digital asset being received at the location;
an act of attaching a corresponding build rule to the digital asset to create a combined data structure that includes the digital asset and the corresponding build rule in response to receiving the digital asset such that the corresponding build rule is stored along with the digital asset and the digital asset and the corresponding build rule can be accessed together in response to a build instruction to build the digital asset for a platform, the contents of the corresponding build rule inherited at least in part from the inheritable build rule;
an act of receiving an instruction to build the digital asset for use on a specified platform;
an act of accessing the combined data structure including the digital asset and the corresponding build rule; and
an act of applying the corresponding build rule from the combined data structure to the digital asset to convert the digital asset to a format compatible with the platform.

2. The method as recited in claim 1, wherein the act of an act of receiving a digital asset at a location within a namespace comprises an act of receiving a digital asset as the result of a drag and drop operation.

3. The method as recited in claim 1, wherein the act of an act of receiving a digital asset at a location within a namespace comprises an act of receiving a digital asset for inclusion in an electronic game.

4. The method as recited in claim 1, wherein the act of an act of receiving a digital asset at a location within a namespace comprises an act of receiving a digital asset selected form among a graphical asset, a video asset, and an audio asset.

5. The method as recited in claim 1, wherein the act of attaching a corresponding build rule to the digital asset comprises an act of attaching a corresponding build rule that was at least partially altered by a user.

6. The method as recited in claim 1, wherein the act of attaching a corresponding build rule to the digital asset to create a combined data structure comprises an act of attaching an inherited platform specific build rule.

7. The method as recited in claim 1, further comprising:
an act of storing the digital asset classification in the combined data structure.

8. At a computer system, a method for building a digital asset for use with a software application, the method comprising:
an act of receiving a digital asset that was exported from a digital asset design application at another computer system;
an act of providing a view of the digital asset to the other computer system through a user inbox for a user of the other computer system;
an act of receiving a build command from the other computer system, the build command indicating a plurality of individual build tasks that are to be performed to appropriately build the digital asset for use with one or more specified platforms;
an act of accessing the digital asset from an asset repository;
an act of distributing the build tasks to slave modules configured to perform individual build tasks such that the build command can be performed in parallel across a plurality of slave modules;
an act of receiving results from each slave module indicating the outcome of one or more distributed build tasks;
an act of storing one or more versions of the digital asset that were built through execution of the one or more distributed tasks;
an act of updating a the view of digital asset at the other computer system to indicate the one more versions of the digital asset that were built for specified platforms.

9. The method as recited in claim 8, wherein the act of receiving a digital asset comprises an act of receiving a digital asset selected form among a graphical asset, a video asset, and an audio asset.

10. The method as recited in claim 8, wherein the act of receiving a digital asset comprises an act of receiving a digital asset associated with one of a plurality of branches of the software application.

11. The method as recited in claim 8, wherein the act of providing a view of digital asset to the other computer system through a user inbox for a user of the other computer system comprises an act of providing a virtual view of a portion of an asset repository that stores digital assets.

12. The method as recited in claim 8, wherein the act of providing a view of digital asset to the other computer system through a user inbox for a user of the other computer system comprises an act of view of one user's inbox to another user of having access to the computer system.

13. The method as recited in claim 8, where the act of receiving a build command from the other computer system comprises an act of receiving a build command to build the digital asset for a plurality of different platforms.

14. The method as recited in claim 8, where the act of receiving a build command from the other computer system comprises an act of receiving a build command to build the digital asset for a computer generated cinematic application.

15. The method as recited in claim 8, wherein an act of distributing the build tasks to slave modules configured to perform individual build tasks comprises:
an act of identifying the current number of available slave modules; and
an act of allocating a task to each available slave module.

16. The method as recited in claim 8, further comprising:
an act of combining the received results into the one or more versions of the digital asset.

17. The method as recited in claim 8, further comprising:
an act of classifying the digital asset as a specified type of digital asset;

18. The method as recited in claim 8, further comprising:
an act of synchronizing the one or more versions of the digital asset with another computer system.

19. The method as recited in claim 8, further comprising:
an act of including a version of the digital asset in one branch of the software application, the one branch of the software application selected from among a plurality of different branches of the software application.

20. A computer system comprising the following:
one or more processors;
system memory;
one or more computer-readable media have store there one computer-executable instructions of a server for controlling the manipulating of digital assets for inclusion in software applications, the server configured to:
receive a digital assets exported from a digital asset design applications at another computer systems;
store the digital asset in a raw format in an asset repository;
classify digital assets into a digital asset type;
receive build commands from the other computer systems, the build commands indicating a plurality of individual build tasks that are to be performed to appropriately build the digital asset for use with one or more specified platforms;
access the digital asset from an asset repository;
distribute the build tasks to slave modules configured to perform individual build tasks such that the build command can be performed in parallel across a plurality of slave modules;
receive results from each slave module indicating the outcome of one or more distributed build tasks; and
storing one or more versions of the digital asset that were built through execution of the one or more distributed tasks for use with the one or more specified platforms.
